(19) United States
(12) Patent Application Publication
(10) Pub. No.: US 2026/0063268 A1
(43) Pub. Date: Mar. 5, 2026

(54) LIGHTING DEVICE FOR A MOTOR VEHICLE

(71) Applicant: Hella GmbH & Co. KGaA, Lippstadt (DE)

(72) Inventor: Martin Mügge, Geseke (DE)

(21) Appl. No.: 19/310,808

(22) Filed: Aug. 26, 2025

(30) Foreign Application Priority Data
Aug. 28, 2024 (DE) 102024124503.4

(51) Int. Cl. F21S 43/20; F21S 43/14; F21S 43/40; F21Y 103/10; F21Y 115/10

(52) U.S. Cl. CPC F21S 43/26231; F21S 43/14; F21S 43/26241; F21S 43/26271; F21S 43/265; F21S 43/402; F21Y 2103/10; F21Y 2115/10

(57) ABSTRACT

A lighting device for a motor vehicle is provided with numerous light sources, at least one optical component in the form of a microstructured film and/or microstructured optical panel, and a collecting and/or focusing lens. The lighting device is configured such that the light from the light sources passes through the collecting and/or focusing lens before passing through the at least one optical component.

### CROSS REFERENCE

This application claims priority to German Application No. 102024124503.4, filed Aug. 28, 2024, the entirety of which is hereby incorporated by reference.

### FIELD OF THE INVENTION

The present invention relates to a lighting device for a motor vehicle.

### BACKGROUND OF THE INVENTION

Design has been a significant factor for some time for signal functions in motor vehicles, e.g. taillights, brake lights, turn signals or daytime running lights, in tail lamps or in headlamps. Since the introduction of LED technology, the design for these lighting devices has become even more important, because the small light-emitting diodes, large numbers of which are frequently used, can be used much more flexibly that a large incandescent lamp as the light source for signal functions, such that, in conjunction with the selected optical system, a large variety of design possibilities are available.

One variation on LED technology is OLED technology, in which the light source does not form of small dots, as is the case with a light-emitting diode, but instead covers a larger surface area to obtain a desired lighting surface that can be lit homogenously. A disadvantage with OLED technology is that it is much more expensive than LED technology. Reasons for this are the complex production process, the different shapes required by the design, and the low demand. In addition, the automotive industry has special requirements such as resistance to UV light and durability with regard to the effects of forces such as vibrations, impacts and shaking, as well as temperatures ranging from −40° C. to +85° C. or +100° C. These requirements are much harder to satisfy for organic light-emitting diodes than for standard light-emitting diodes.

Consequently, alternatives have been sought for obtaining similar designs to those with organic light-emitting diodes (OLEDs), in particular for homogenously lit surfaces. This has been achieved with the use of light-emitting diodes (LEDs) with a flat optical waveguide and optical elements in the form of microstructured films or thin optical panels that diffuse the light emitted from the optical waveguide. This results in a flat light module with which a high performance level, which can light the entire surface homogenously.

Just like with organic light-emitting diodes, when numerous flat light modules are integrated in taillights, they can be placed adjacent to and behind one another, to generate the desired individual appearance of the signal function, e.g. for taillights or rear brake lights. Furthermore, instead of individual modules, a flat light module can be designed as a large flat lighting element. This flat lighting device can also be used for backlighting displays.

A lighting device of the type specified above is disclosed in DE 10 2021 122 264 A1. This lighting device is in the form of a flat light module and contains numerous light sources in the form of light-emitting diodes (LEDs) and a flat optical waveguide with an entry surface and at least one exit surface, the entry surface of which is an end surface of the optical waveguide. The lighting device also contains two optical panels that each have at least one structure, through which the light emitted from the exit surface passes successively. The structuring of the second optical panel through which the light passes is formed by an array of triangular prisms, which are adjacent to one another in one direction, and parallel in a second direction, perpendicular to the first direction. Each of the prisms has two angled sides, the edges of which form adjoining edges extending in the second direction, which meet at a 90° angle.

An exemplary lighting device in the form of a flat light module from the prior art is shown in FIGS. 13 and 14. This flat light module has a light source containing numerous light-emitting diodes (LEDs). The flat light module also has a housing 2 with front and back parts 2a, 2b that are snapped together. There is a plate-shaped optical waveguide 3 between the parts 2a, 2b of the housing that has micro-optical elements, a white diffusing reflective film 4 behind the optical waveguide 3, and two or three optical components 5a, 5b in the form of micro-optical films are placed in front of the waveguide 3, which are responsible on the whole for the light distribution and the efficiency of the system in that the individual micro-optical components are coordinated to one another. The basis for this fundamental structure is to obtain a lighting element with a uniformly, homogenously lit surface. The lighting device has a cover lens 6 for this that serves as the surface through which the light from the lighting device exits.

The optical component 5a adjacent to the waveguide 3 diffuses light, while the second optical component 5b is a so-called BEF optical element. BEF stands for “brightness enhancement film” in this context. A BEF therefore enhances the brightness of the light passing through the optical component 5b. The BEF can be a film or a thin lens. Some systems have two orthogonal BEFs, in which case the diffusor is sometimes omitted.

The BEF disclosed in DE 10 2022 113 052 A1 contains an array of linear triangular prisms 7, illustrated in FIG. 15. Each of these prisms 7 has an apex angle α of 90°.

This technology, or the structure of the flat light module with optical waveguides and optical panels and/or films in a flat housing and with a cover lens is efficient when the flat light module forms a large rectangular or square lighting surface. The light entering the waveguide in the flat light module requires a path that is long enough to obtain an efficient system for homogenously lighting the exit surface on the lighting device. If the optical path is shortened in the waveguide, e.g. because the surface that is to be lit in the module is narrow, the waveguide becomes inefficient.

### BRIEF SUMMARY OF THE INVENTION

The fundamental problem addressed by the present invention is to therefore create a lighting device of the type described above with which an efficient and homogenous lighting of the exit surface is obtained despite a narrow exit surface.

In an example embodiment, the lighting device contains numerous light sources, at least one optical component in the form of a microstructured film and/or microstructured optical panel, and a collecting and/or focusing lens, in which the lighting device is configured such that the light from the light sources passes through the collecting and/or focusing lens before passing through the at least one optical component.

The light sources can be placed next to one another in a row. They can also be placed in two or more rows that are close together. In particular, these light sources can be light-emitting diodes (LEDs). The light-emitting diodes can populate a single printed circuit board, which is painted white in order to reflect any light reflected backward in the system back toward the front.

By eliminating an optical waveguide, the at least one optical panel can be backlit directly by the light sources through the collecting and/or focusing lens. Consequently, a narrow, in particular substantially linear exit surface on the lighting device can be efficiently lit. This design also results in a lighting device that weighs less and requires less installation space than a lighting device with a flat light module.

The collecting and/or focusing lens can be a Fresnel lens. This Fresnel lens can have an entry surface and an exit surface for the light from the light sources, both of which can be structured to diffuse light. A Fresnel lens can be very compact, thus requiring only a shallow installation space for the lighting device. Furthermore, the structure on the Fresnel lens can contribute to shaping the light, in particular to homogenizing the light.

The collecting and/or focusing lens can also be a TIR lens. A TIR lens subjects at least part of the light to total internal reflection. This TIR lens can have an entry surface and an exit surface for the light from the light sources, both of which may be structured to diffuse light. A TIR lens can also be very compact, thus requiring only a shallow installation space for the lighting device. Furthermore, the structure on the TIR lens can contribute to shaping the light, in particular to homogenizing the light.

The collecting and/or focusing lens can have numerous optical sectors, each of which has a dedicated light source, such that the light from each of the light sources passes through a specific optical sector. Each of the optical sectors can contain a lens. This ensures that the light from each light source is steered in a targeted manner to strike the at least one optical component.

The lighting device can contain numerous optical components in the form of microstructured films and/or microstructured optical panels, wherein the lighting device is then configured such that the light exiting the collecting and/or focusing lens passes through the numerous optical components successively. The numerous optical components can collectively ensure a desired diffusion and therefore a homogenous lighting of the exit surface.

The at least one optical component, or at least one of the optical components, can have a diffusing structure. A diffusing structure diffuses the light appropriately.

The at least one optical component, or at least one of the optical components, can have an array of triangular prisms. This results in a BEF. BEF stands for “brightness enhancement film” in this context. The BEF enhances the brightness of the light passing through the optical component.

The at least one optical component, or at least one of the optical components, can have an array of deflecting prisms configured to deflect light passing through the optical component such that the mean direction of the light in front of the optical component is at an angle other than 0° to the mean direction of the light behind the optical component. This optical component therefore has a so-called DTF. DTF stands for “direction turning film.” In this case, an optical element formed with linear prisms deflects light back into the main beam direction, e.g. in a rotated system. With a DTF, the light from the light sources in a rotated lighting device can be deflected such that it exits the lighting device in the desired direction, parallel to the direction of travel. The angle of the prisms in this case can substantially correspond to the angle at which the lighting device is rotated.

The lighting device can have a cover lens, in which case the lighting device is configured such that at least part of the light that passes through the at least one optical component exits the lighting device through the cover lens. This cover lens can have a diffusing structure. Consequently, the cover lens can also contribute to shaping the light, in particular to homogenizing the light.

A first surface of the at least one optical component, or a first optical component, can have a diffusing structure, and a second surface of the at least one optical component, or a second optical component, can have an array of triangular prisms. The diffusing structure can diffuse the light to improve the homogeneity of the lit surface. The BEF can enhance the brightness of the light passing through the optical component. Both surfaces, or optical components, can collectively ensure an efficient lighting of the exit surface on the lighting device.

A first surface of the at least one optical component, or a first optical component, can have an array of triangular prisms that are adjacent to one another in a first direction and parallel in a second direction, perpendicular to the first, and a second surface of the at least one optical component, or a second optical component, can have an array of triangular prisms that are adjacent to one another in the second direction, and parallel in the first direction. These crossing arrays of prisms improve the homogeneity of the lighting and simultaneously increase the intensity in the center slightly, which has advantages with regard to an efficient lighting of a signal function that has this type of lighting system.

One surface of the at least one optical component, or a third optical component, can have an array of light-deflecting prisms. This DTF can deflect the light from the light sources in a rotated lighting device such that it exits in a desired direction that is parallel to the direction of travel.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a side view of a first example embodiment of the lighting device obtained with the invention.

FIG. 2 shows a detailed view corresponding to the arrow II in FIG. 1.

FIG. 3 shows a perspective detailed view of a second example embodiment of the lighting device obtained with the invention.

FIG. 4 shows a side view of a detail of the lighting device shown in FIG. 3.

FIG. 5 shows a perspective detailed view of a third example embodiment of the lighting device obtained with the invention.

FIG. 6 shows another perspective detailed view of the lighting device shown in FIG. 5.

FIG. 7 shows another perspective detailed view of the lighting device shown in FIG. 5.

FIG. 8 shows another perspective detailed view of the lighting device shown in FIG. 5.

FIG. 9 shows a side view of a fourth example embodiment of the lighting device obtained with the invention.

FIG. 10 shows a side view of a fifth example embodiment of the light device obtained with the invention with a single beam path of the light.

FIG. 11 shows a side view of the lighting device shown in FIG. 10.

FIG. 12 shows a side view of a sixth example embodiment of the lighting device obtained with the invention, with a single beam path of the light.

FIG. 13 shows a perspective view of the lighting device from the prior art.

FIG. 14 shows an exploded view of the lighting device shown in FIG. 13.

FIG. 15 shows a cut through the optical component in the lighting device shown in FIG. 13.

### DETAILED DESCRIPTION OF THE DRAWINGS

The same reference symbols are used for identical or functionally identical components in the drawings.

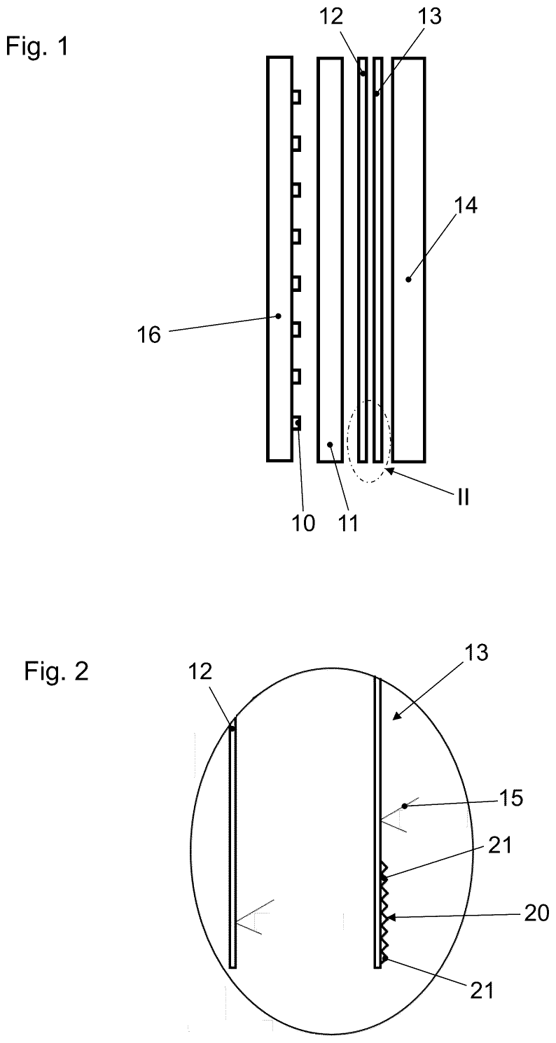

The lighting device shown in the drawings contains numerous light sources 10, a collecting and/or focusing lens 11, two optical components 12, 13 in the form of microstructured films and/or microstructured optical panels, and a cover lens 14 (see FIG. 1). The lighting device is configured such that the light 15 from the light sources 10 passes through the collecting and/or focusing lens 11, then through the two optical components 12, 13, and subsequently at least partially through the cover lens 14, exiting the lighting device.

The lighting device does not have to have a cover lens 14. There can also be more than two optical components 12, 13, or just one optical component 12, 13.

The light sources 10 are light-emitting diodes (LEDs). A printed circuit board 16 is shown in FIG. 1, which is populated with the light sources 10. The printed circuit board 16 can be painted white in order to reflect the light reflected back by the system back toward the front.

The numerous light-emitting diodes can be different colors to obtain a dual function or triple function, for example. The light-emitting diodes can alternate between red and yellow, or white and yellow, or white and cyan, or bicolored LEDs or RGB LEDs can be used. The functions can be navigation lights, daytime running lights and an autonomous driving function, which requires cyan lights.

The light sources 10 are adjacent to one another in a row. The light sources 10 can also be in two or more rows that are close to one another.

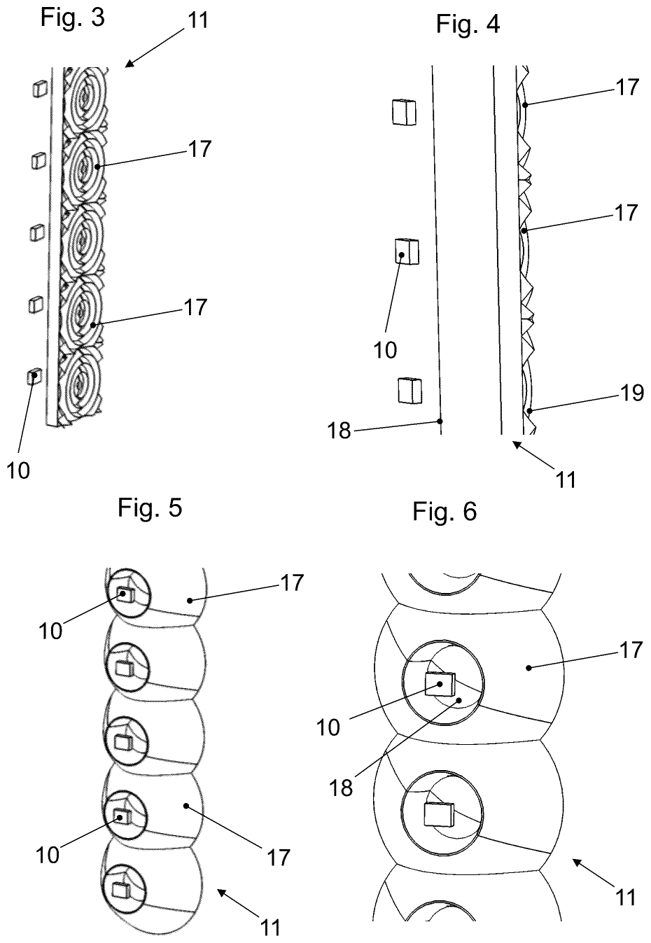

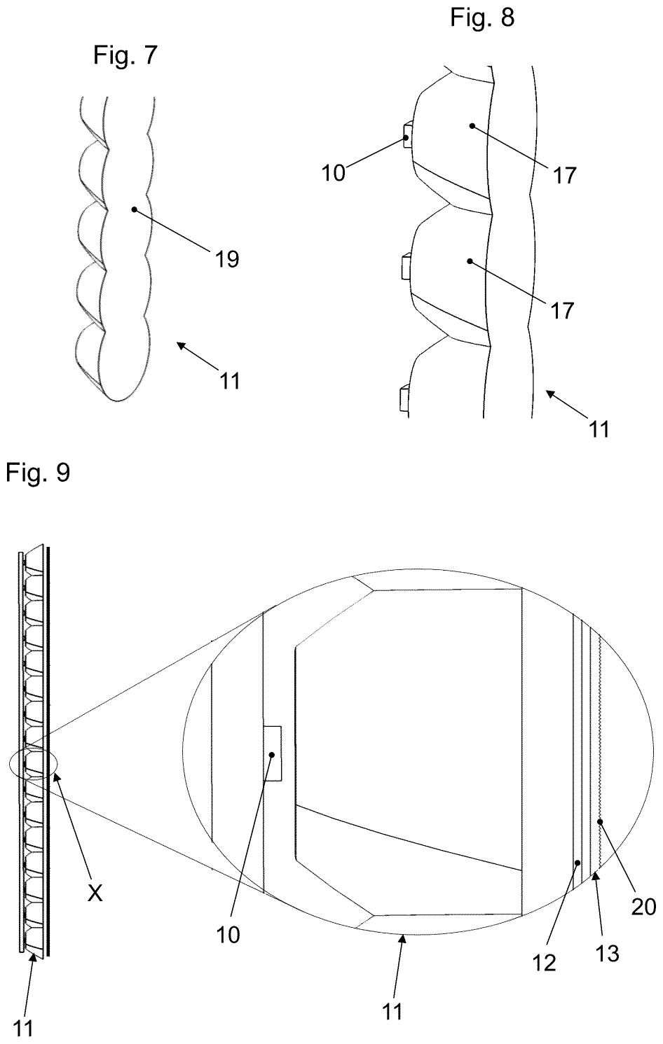

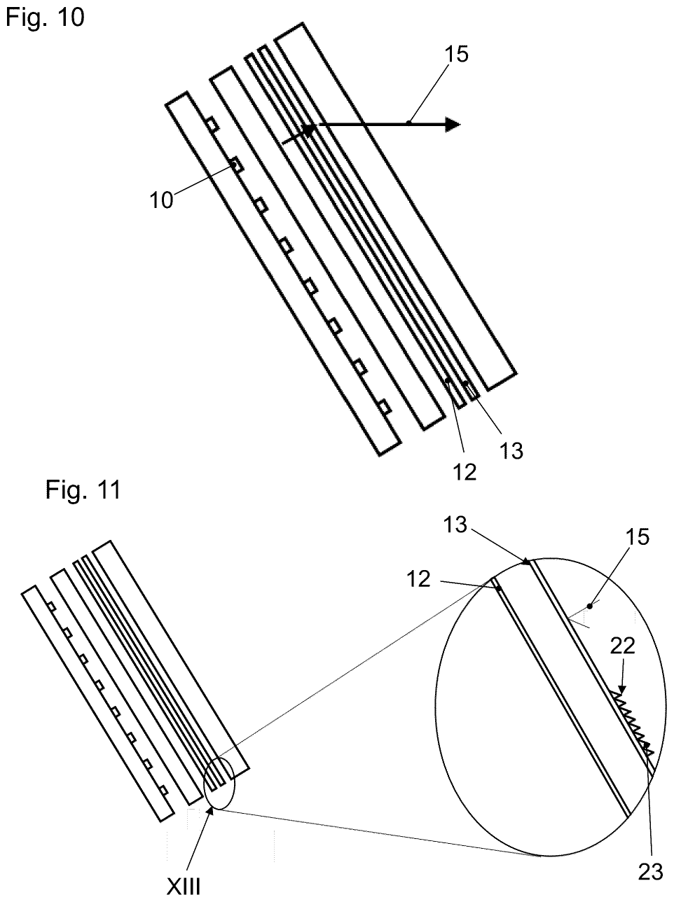

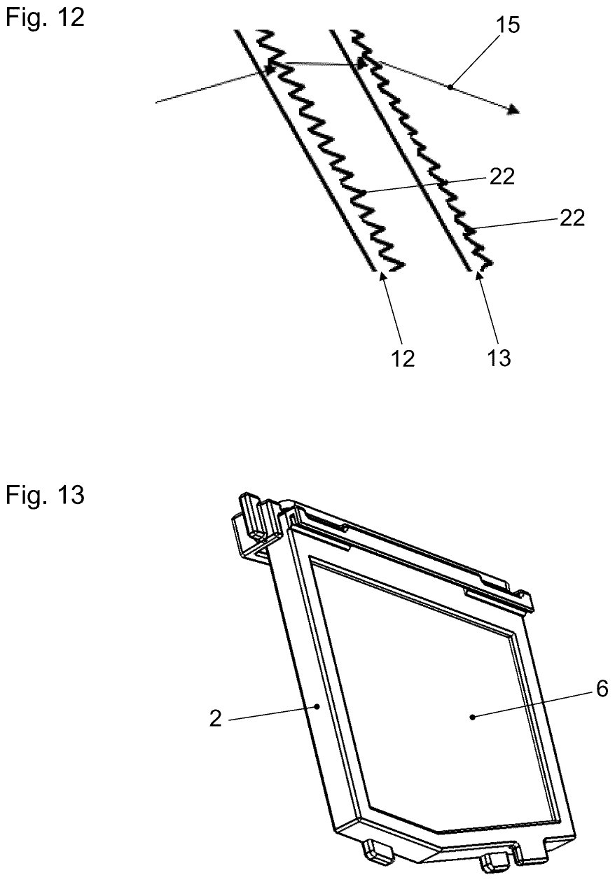

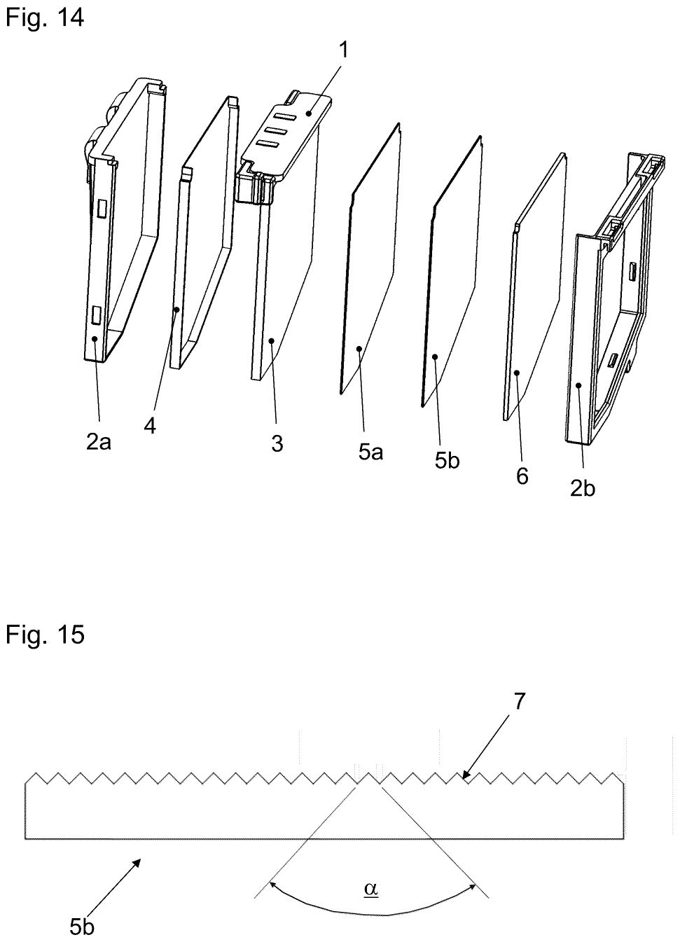

The collecting and/or focusing lens 11 contains numerous optical sectors 17 (see FIGS. 3 to 8). Each optical sector 17 has a lens. Each optical sector 17 has a dedicated light source 10, such that the light 15 from each light source 10 passes through its own optical sector. The lens 11 has an entry surface 18 and an exit surface 19 for the light 15 from the light sources 10 (see FIGS. 4, 6 and 8).

In the embodiment shown in FIGS. 3 and 4 the collecting and/or focusing lens 11 is a Fresnel lens. The entry surface 18 on the Fresnel lens is planar while the exit surface 19 has Fresnel structures. The Fresnel structures could be on the entry surface 18 and the exit surface 19 could be planar.

The planar surface of the Fresnel lens can be structured, in particular with a diffusing structure. It is also possible for the surface with the Fresnel structure to have a diffusing structure.

In the embodiment shown in FIGS. 5 to 8 the collecting and/or focusing lens 11 can be a TIR lens. The entry surface 18 and exit surface 19 are curved in this case. Either of the surfaces could also be planar, in particular the exit surface 19. The entry surface 18 and/or exit surface could also have a diffusing structure.

The first optical component 12 in the embodiment in FIGS. 1 and 2 has a diffusing optical element. This diffusor optical element can be on the entry surface and/or the exit surface of the first optical component 12.

The second optical component 13 in the embodiment in FIGS. 1 and 2 has a BEF. FIG. 2 shows an array 20 of triangular prisms 21 forming the BEF, which is on the exit surface of the second optical component 13. The BEF could also be on the entry surface of the second optical component 13. In particular, arrays 20 of prisms 21 on the entry surface and exit surface of the second optical component 13 could be perpendicular to one another, in that the peaks of the prisms 21 on the entry surface run in a first direction, and the peaks of the prisms 21 on the exit surface run in a second direction, at a right angle to the first.

The second optical component 13 in the embodiment in FIGS. 10 and 11 has a DTF. FIG. 11 shows an array of deflecting prisms 23 forming the DTF, which is on the exit surface of the second optical component 13. These prisms 23 are configured to deflect the light passing through the second optical component 13 such that the mean direction of the light in front of the optical component is at an angle to the mean direction of the light behind the optical component. The angle in this exemplary embodiment is approx. 30° (see FIGS. 10 and 11). This angle can also be different.

The entry surface of the second optical component 13 can also have a DTF. It is also possible to place an array 22 of deflecting prisms 23 on both the first optical element 12 and the second optical element 13, which form a DTF (see FIG. 14).

The cover lens 14 can also have a diffusing structure.

The lighting device can have different types of optical components or functional structures. Some examples of these are given below.
A diffusing optical element followed by a horizontal BEF, followed by a vertical BEF.
A diffusing optical element followed by a horizontal BEF, followed by a vertical BEF, followed by a structured or unstructured cover lens.
A horizontal BEF followed by a vertical BEF.
A horizontal BEF followed by a vertical BEF, followed by a structured or unstructured cover lens.
A diffusing optical element followed by a horizontal BEF, followed by a DTF.
A diffusing optical element followed by a horizontal BEF, followed by a DTF, followed by a structured or unstructured cover lens.

This is merely a list of examples and is not to be regarded as definitive. There are other possible combinations of optical components and functional structures for the lighting device.

### LIST OF REFERENCE SYMBOLS

1 light source
2 housing
2a, 2b housing parts
3 optical waveguide
4 reflecting film
5a, 5b micro-optical film
6 cover lens
7 triangular prisms on 5b
10 light source
11 collecting and/or focusing lens
12 first optical component
13 second optical component
14 cover lens
15 light from the light source
16 printed circuit board
17 optical sector of the collecting and/or focusing lens
18 entry surface on the collecting and/or focusing lens
19 exit surface on the collecting and/or focusing lens
20 array of triangular prisms
21 triangular prism
22 array of deflecting prisms
23 deflecting prism
α apex angle of the triangular prism

1. A lighting device for a motor vehicle, the lighting device comprising:
numerous light sources;
at least one optical component, the at least one optical component being a microstructured film and/or microstructured optical panel; and
a collecting and/or focusing lens,
wherein light from the light sources passes through the collecting and/or focusing lens before passing through the at least one optical component.

2. The lighting device according to claim 1, wherein the collecting and/or focusing lens is a Fresnel lens.

3. The lighting device according to claim 2, wherein the Fresnel lens has an entry surface and exit surface for the light from the light sources, wherein the entry surface and/or exit surface on the Fresnel lens have a diffusing structure.

4. The lighting device according to claim 1, wherein the collecting and/or focusing lens is a TIR lens.

5. The lighting device according to claim 4, wherein the TIR lens has an entry surface and exit surface for the light from the light sources, wherein the entry surface and/or exit surface of the TIR lens have a diffusing structure.

6. The lighting device according to claim 1, wherein the collecting and/or focusing lens has numerous optical sectors, wherein each optical sector has a dedicated light source, such that the light from the light source passes through its own optical sector.

7. The lighting device according to claim 1, wherein the lighting device has numerous optical components in the form of microstructured films and/or microstructured optical panels, wherein light exiting the collecting and/or focusing lens passes through the optical components successively.

8. The lighting device according to claim 1, wherein at least one of the at least one optical component has a diffusing structure.

9. The lighting device according to claim 1, wherein at least one of the at least one optical component has an array of triangular prisms.

10. The lighting device according to claim 1, wherein at least one of the at least one optical component has an array of deflecting prisms configured to deflect light passing through the optical components such that a mean direction of the light in front of the optical components is at an angle other than 0° to a mean direction of light behind the optical components.

11. The lighting device according to claim 1, wherein the lighting device has a cover lens, wherein at least part of the light exits the lighting device through the cover lens after passing through the at least one optical component.

12. The lighting device according to claim 11, wherein the cover lens is structured.

13. The lighting device according to claim 1, wherein a first surface of the at least one optical component or a first optical component has an array of triangular prisms which are adjacent to one another in a first direction, and parallel in a second direction which is perpendicular to the first direction, and wherein a second surface of the at least one optical component, or a second optical component has an array of triangular prisms, which are adjacent to one another in the second direction, and parallel in the first direction.

14. The lighting device according to claim 1, wherein a first surface of a first of the at least one optical component has a diffusing structure, and a second surface of the first optical component, or a second of the at least one optical component has an array of triangular prisms.

15. The lighting device according to either of the claims 13, wherein one surface of the first optical component, or a third of the at least one optical component has an array of deflecting prisms.

16. The lighting device according to claim 12, wherein the cover lens is structured with a diffusing structure.
